(19) United States
(12) Patent Application Publication
(10) Pub. No.: US 2009/0106886 A1
(43) Pub. Date: Apr. 30, 2009

(54) Automatic hinge module and apparatus having the same for opening and closing toilet bowl

(75) Inventors: Sung-Tai Jung, Suwon-si (KR); Sung-Bum Kim, Anyang-si (KR); Yun-Mo Kang, Seoul (KR); Ga-Young An, Buk-gu (KR); Seong-Geun Kim, Suwon-si (KR); Myung-Geun Oh, Ansan-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/076,652

(22) Filed: Mar. 20, 2008

(30) Foreign Application Priority Data
Oct. 30, 2007 (KR) 10-2007-0109303

(51) Int. Cl. A47K 13/10; F03G 1/08

(52) U.S. Cl. 4/246.1; 185/40 R

(57) ABSTRACT

An automatic hinge module and apparatus for opening and closing a toilet bowl. The module includes: a motor, which generates a driving force; a housing, of which one end is coupled to a body of the motor; a drive shaft, which is rotatably coupled to the housing, and which has one end coupled to an output shaft of the motor, such that the centers of rotation of the drive shaft and the output shaft coincide, to allow the drive shaft to transfer the driving force to the exterior; and a spring, one end of which is coupled to the housing, and the other end of which is coupled to the drive shaft, such that the spring provides an elastic force to the drive shaft in a direction of rotation of the drive shaft. Using this module, the cover and seat of a toilet can be opened and closed automatically.

### CROSS-REFERENCE TO RELATED APPLICATIONS

This application claims the benefit of Korean Patent Application No. 10-2007-0109303 filed with the Korean Intellectual Property Office on Oct. 30, 2007, the disclosure of which is incorporated herein by reference in its entirety.

### BACKGROUND

1. Technical Field

The present invention relates to an automatic hinge module and an apparatus equipped with the automatic hinge module for opening and closing a toilet bowl.

2. Description of the Related Art

Before, when a person used a toilet in a domestic home or in a shopping center, etc., the person manually opened or closed the cover or seat of the toilet bowl, and was thus exposed to germs, etc. In order to provide better hygiene, an apparatus was developed which used a power supply for automatically opening and closing the cover and seat of the toilet bowl. However, due to the weight of the toilet cover and seat, a large driving force was required, which raised manufacturing costs and increased the volume of the opening/closing apparatus.

An apparatus for opening and closing the cover and seat according to the related art may include a support rack coupled to the toilet bowl, a cover and seat rotatable coupled to the support rack, and a power supply that rotates the cover and seat. In this way, the power supply may be coupled to rotate the cover and seat, so that the cover and seat may be opened and closed. However, due to the installing of a power supply corresponding to the weight of the cover and seat, as well as of the equipment associated with transferring the driving force, the volume of the opening/closing apparatus may be increased, and the manufacturing costs may be raised, posing difficulties in commercialization.

As such, there is a need for an automatic hinge module and an apparatus for opening and closing a toilet bowl, which can supplement the driving force provided by the power supply, while allowing a reduced size for the apparatus.

### SUMMARY

An aspect of the invention is to provide an automatic hinge module and an apparatus for opening and closing a toilet bowl, which are capable of automatically opening and closing the cover and seat of a toilet bowl, providing an elastic force that supplements the driving force of the power supply, and sensing the amount of rotation of the cover and seat.

One aspect of the invention provides an automatic hinge module that includes: a motor, which generates a driving force; a housing, of which one end is coupled to a body of the motor; a drive shaft, which is rotatably coupled to the housing, and which has one end coupled to an output shaft of the motor, such that a center of rotation of the drive shaft coincides with a center of rotation of the output shaft, to allow the drive shaft to transfer the driving force to the exterior; and a spring, one end of which is coupled to the housing, and the other end of which is coupled to the drive shaft, such that the spring provides an elastic force to the drive shaft in a direction of rotation of the drive shaft.

A first securing indentation may be formed inside the housing, with a portion of the first securing indentation having a width smaller than or equal to a diameter of the one end of the spring, and one end of the spring may be held in the first securing indentation in a manner of a press fit.

A second securing indentation may be formed in the drive shaft that opens towards one end of the drive shaft, and the other end of the spring may be held in the second securing indentation.

The spring can be a coil spring wound around a perimeter of the drive shaft.

The automatic hinge module may further include a rotation sensor, which can be coupled to the housing, to sense a rotation angle of the drive shaft and generate an output signal corresponding to the rotation angle, when the drive shaft is rotated.

The rotation sensor can generate a direction signal as the output signal, to determine an operating direction of the motor.

The rotation sensor can also generate a stop signal as the output signal, to stop an operation of the motor.

The automatic hinge module may further include a shaft gear coupled to one end of the drive shaft, and a sensor gear meshed with the shaft gear and coupled to one end of the rotation sensor.

The rotation sensor may be sealed from the exterior.

The rotation sensor can be interposed between the housing and the body of the motor, and one end of the housing can be coupled to the body of the motor with a sealant interposed in-between.

Another aspect of the invention provides an apparatus for opening and closing a toilet bowl, which includes: a base coupled to the toilet bowl; a seat rotatably coupled to the base about an imaginary axis of rotation; a cover rotatably coupled to the seat about the imaginary axis of rotation; a motor, which is coupled to the base, and which is configured to generate a driving force; a housing having one end coupled to a body of the motor; a drive shaft, which is rotatably coupled to the housing, and which has one end coupled to an output shaft of the motor, such that a center of rotation of the drive shaft coincides with a center of rotation of the output shaft, and the other end coupled to at least one of the seat and the cover; and a spring, of which one end is coupled to the housing, and the other end is coupled to the drive shaft, such that the spring provides an elastic force to the drive shaft in a direction of rotation of the drive shaft.

There can be multiple motors, housings, drive shafts, and springs, where one of the drive shafts can have the other end coupled to the seat to transfer the driving force to the seat, while another of the drive shafts can have the other end coupled to the cover to transfer the driving force to the cover.

A first securing indentation may be formed inside the housing, with a portion of the first securing indentation having a width smaller than or equal to a diameter of the one end of the spring, and one end of the spring may be held in the first securing indentation in a manner of a press fit.

A second securing indentation may be formed in the drive shaft that opens towards one end of the drive shaft, and the other end of the spring may be held in the second securing indentation.

The spring can be a coil spring wound around a perimeter of the drive shaft.

The automatic hinge module may further include a rotation sensor, which can be coupled to the housing, to sense a rotation angle of the drive shaft and generate an output signal corresponding to the rotation angle, when the drive shaft is rotated.

The rotation sensor can generate a direction signal as the output signal, to determine an operating direction of the motor.

The rotation sensor can also generate a stop signal as the output signal, to stop an operation of the motor.

The automatic hinge module may further include a shaft gear coupled to one end of the drive shaft, and a sensor gear meshed with the shaft gear and coupled to one end of the rotation sensor.

The rotation sensor may be sealed from the exterior.

The rotation sensor can be interposed between the housing and the body of the motor, and one end of the housing can be coupled to the body of the motor with a sealant interposed in-between.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of an automatic hinge module according to a first disclosed embodiment of the invention.

FIG. 2 is an exploded perspective view of an automatic hinge module according to the first disclosed embodiment of the invention.

FIG. 3 is a cross-sectional view illustrating the coupling between the housing and the spring in an automatic hinge module according to the first disclosed embodiment of the invention.

FIG. 4 is a perspective view illustrating the coupling between the drive shaft and the spring in an automatic hinge module according to the first disclosed embodiment of the invention.

FIG. 5 is a perspective view illustrating the coupling of the spring in an automatic hinge module according to the first disclosed embodiment of the invention.

FIG. 6 is a perspective view of an apparatus for opening and closing a toilet bowl according to a second disclosed embodiment of the invention.

FIG. 7 is a bottom view of an apparatus for opening and closing a toilet bowl according to the second disclosed embodiment of the invention.

### DETAILED DESCRIPTION

The automatic hinge module and apparatus equipped with the automatic hinge module for opening and closing a toilet bowl, according to certain embodiments of the invention, will be described below in more detail with reference to the accompanying drawings. Those components that are the same or are in correspondence are rendered the same reference numeral regardless of the figure number, and redundant explanations are omitted.

Such terms as “first” and “second,” etc., merely serve to distinguish one component from another. Components that are the same or are in corresponding relationships are not to be limited by the terms such as “first” and “second,” etc.

Also, if a component is described to be coupled to another component, the coupling not only refers to those cases where the components are in direct physical contact, but also encompasses those cases where a different element or elements are interposed between the components mentioned, with the components being in contact with the different element or elements respectively.

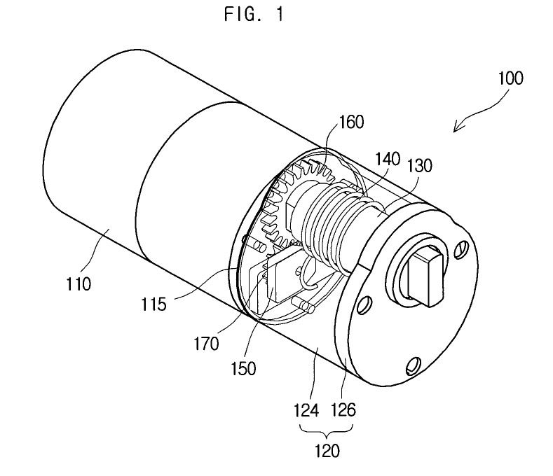

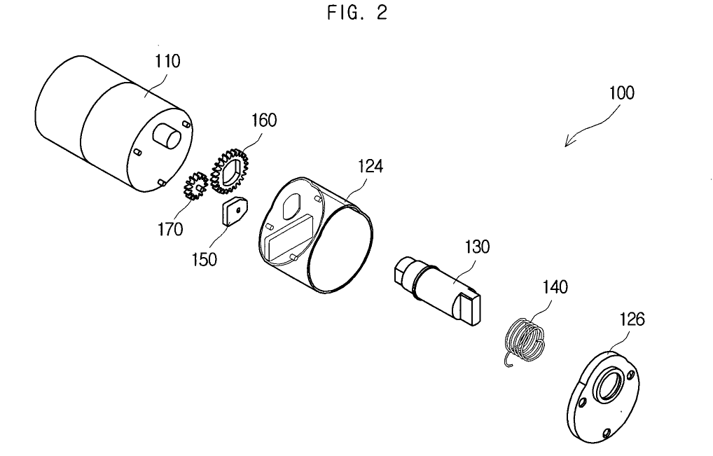

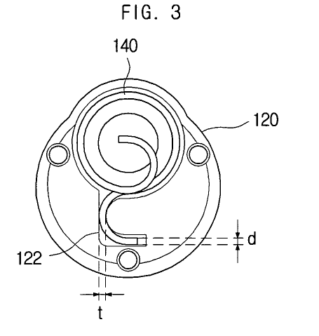

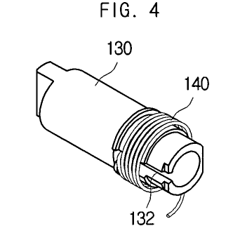

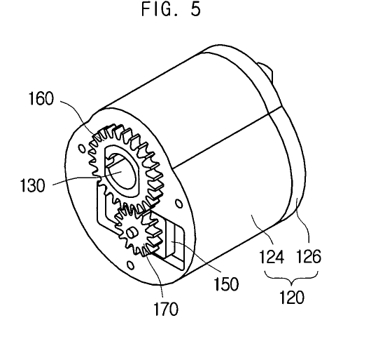

FIG. 1 is a perspective view of an automatic hinge module according to a first disclosed embodiment of the invention, and FIG. 2 is an exploded perspective view of an automatic hinge module according to the first disclosed embodiment of the invention. FIG. 3 is a cross-sectional view illustrating the coupling between the housing and the spring in an automatic hinge module according to the first disclosed embodiment of the invention, FIG. 4 is a perspective view illustrating the coupling between the drive shaft and the spring in an automatic hinge module according to the first disclosed embodiment of the invention, and FIG. 5 is a perspective view illustrating the coupling of the spring in an automatic hinge module according to the first disclosed embodiment of the invention.

In FIGS. 1 to 5, there are illustrated an automatic hinge module 100, a motor 110, a sealant 115, a housing 120, a first securing indentation 122, a housing body 124, a housing cover 126, a drive shaft 130, a second securing indentation 132, a spring 140, a rotation sensor 150, a shaft gear 160, and a sensor gear 170.

An automatic hinge module 100 is disclosed in this embodiment. Here, a drive shaft 130 can be connected with an output shaft of a motor 110 such that the centers of rotation of the drive shaft 130 and the output shaft coincide, and a spring 140 that supplements the driving force of the motor 110 can be coupled to a housing 120 and the drive shaft 130, to provide a smaller size for the automatic hinge module 100. Also, a rotation sensor 150 can be coupled to the housing 120, to sense the rotation of the output shaft of the motor 110 and generate a corresponding output signal.

The motor 110 may generate a driving force, and the body of the motor 110 can be coupled to one end of the housing 120. With the body of the motor 110 coupled to the housing 120, and the drive shaft 130, spring 140, and rotation sensor 150, etc., equipped inside the housing 120, the driving apparatus can be modularized, for easier application, for example, in an opening and closing apparatus for a toilet bowl.

The motor 110 can be a geared motor 110 integrated with a gear box, for example, whereby the torque and number of revolutions of the motor 110 may readily be adjusted without the use of a separate device.

The housing 120 can be made of a housing body 124 and a housing cover 126, where the body of the motor 110 can be coupled to one end of the housing 120, while the drive shaft 130 and the spring 140 can be coupled to the inside of the housing 120. In addition, the rotation sensor 150 can be placed between the housing 120 and the body of the motor 110. Also, one end of the housing 120 can be coupled to the body of the motor 110 with a sealant 115 placed in-between, to prevent moisture, etc., from infiltrating the rotation sensor 150 from the exterior. This will be described in more detail later, when describing the rotation sensor 150.

In the inside of the housing 120, as illustrated in FIG. 3, a first securing indentation 122 may be formed, a portion of which has a width (t) smaller than or equal to the diameter (d) of one end of the spring 140. The one end of the spring 140 can be held in this first securing indentation 122, so that a press fit may be formed by the end of the spring 140 and the portion of the first securing indentation 122.

When the spring 140 is manufactured, errors may occur that cause the product to deviate from the intended design. Because of this possibility, if the first securing indentation 122 is formed to have the same shape as that of the intended design of the spring 140, the spring 140 may not be assembled into the first securing indentation 122, and thus defects may occur.

Moreover, forming the first securing indentation 122 to be greater than the size of the one end of the spring 140, in an effort to prevent the problem described above, may cause backlashes at the output shaft of the motor 110 and the drive shaft 130. This can lead to even greater backlash at the further end of the object rotated by the drive shaft 130, such as the cover and/or seat of the toilet bowl.

The above problems can be prevented in the following manner. The first securing indentation 122 may be formed in the housing 120, such that the width (t) of one portion is smaller than or equal to the diameter (d) of the end of the spring 140, and the end of the spring 140 may be forced into the first securing indentation 122 for assembly. Thus, this portion of the first securing indentation 122 can have the end of the spring 140 press-fitted in, while the remaining portions of the first securing indentation 122 can be spaced apart from the end of the spring 140. By utilizing this arrangement, the problems described above can be resolved.

The drive shaft 130 may be rotatably coupled to the housing 120, and may have one end coupled to the output shaft of the motor 110 such that the center of rotation of the drive shaft 130 coincides with the center of rotation of the output shaft. With this arrangement, the drive shaft 130 may transfer the driving force to the rotated object, such as the cover or seat, etc., of the toilet bowl.

By having one end of the drive shaft 130 connected directly to the output shaft of the motor 110, a more compact automatic hinge module 100 can be implemented, compared to the case of altering the center of rotation using a gear train, etc.

Also, as illustrated in FIG. 4, a second securing indentation 132 may be formed in the drive shaft 130 that is open towards one end of the drive shaft 130, where the other end of the spring 140 may be held in the second securing indentation 132.

A conventional structure, in which an indentation is made in the perimeter of the drive shaft 130 for securing the other end of the spring 140, may not allow easy assembly, and to facilitate the assembly, the coupling portion on the other end of the spring 140 may have to be designed to have a short length. Thus, when a large force is applied on the spring 140, the spring 140 may easily slip out from the drive shaft 130.

As such, by forming the second securing indentation 132 that opens to one end of the drive shaft 130 and placing the other end of the spring 140 inside the second securing indentation 132 to improve workability in assembling and linking the spring 140, the problems described above of inconvenient assembly and of the spring 140 easily slipping from the drive shaft 130, etc., can be avoided.

The spring 140 can be a torsion spring that has one end coupled to the housing 120 and the other end coupled to the drive shaft 130 to provide an elastic force on the drive shaft 130 in the rotational direction of the drive shaft 130. That is, by pre-stressing the spring 140, the spring 140 can be made to provide an elastic force on the output shaft of the motor 110, when the motor 110 is started, to supplement the driving force of the motor 110 and allow a smoother operation of the motor 110.

Looking as an example at an apparatus for opening and closing a toilet bowl equipped with an automatic hinge module 100 according to this embodiment, the spring 140 can be coupled such that a compressive force is applied to the spring 140 when the cover and seat are both closed. Then, when the cover or seat begins to rotate, the spring 140 may apply an elastic force in the direction of rotation to facilitate the movement of the cover or seat.

The spring 140 can be a coil spring wound around the perimeter of the drive shaft 130, and may not necessarily require a separate space for the coupling of the spring 140, whereby it is possible to implement an even smaller automatic hinge module 100.

An example of how the spring 140 can be coupled is illustrated in FIG. 3 and FIG. 4. The first securing indentation 122 may be formed in the inside of the housing 120 with the width (t) of one portion of the first securing indentation 122 being smaller than or equal to the diameter (d) of one end of the spring 140, and one end of the spring 140 may be held in the first securing indentation 122 for a press fit with the portion of the first securing indentation 122. The second securing indentation 132 may be formed in the drive shaft 130 that opens to one end of the drive shaft 130, and the other end of the spring 140 may be held in the second securing indentation 132. Detailed descriptions of the first securing indentation 122 and second securing indentation 132 have already been presented in the descriptions of the housing 120 and the drive shaft 130, and thus will not be repeated.

A control unit (not shown) may control the operation of the motor 110. That is, the sensor may sense changes in the operation of the automatic hinge module 100 and generate an output signal, which can be received by the control unit (not shown) to generate a signal for operating or stopping the motor 110.

For example, in an apparatus for opening and closing a toilet bowl equipped with an automatic hinge module 100, a sensor which senses the rotation of the drive shaft 130, i.e. the rotation sensor 150, can generate an output signal, which can be received and compared with a preset value inputted by the user to determine whether or not to operate the motor 110.

The control unit (not shown) can be coupled to the housing 120 of the automatic hinge module 100. Of course, the control unit (not shown) can also be coupled, for example, to the base of the apparatus for opening and closing a toilet bowl, to which the automatic hinge module 100 is equipped, as long as an electrical connection is maintained with the rotation sensor 150.

The rotation sensor 150 may be coupled to the housing 120, and when the drive shaft 130 is rotated, may sense the amount of rotation of the drive shaft 130 and generate an output signal corresponding to the amount of rotation. That is, the rotation sensor 150 may sense the angle by which the drive shaft 130 has rotated to generate a direction signal that determines the operating direction of the motor 110, and may sense the angle by which the drive shaft 130 is rotating to generate a stop signal as the output signal that stops the operation of the motor 110. Then, in accordance to the direction signal or stop signal, the control unit (not shown) may determine the rotating direction of the output shaft of the motor 110 or stop the operation of the motor 110.

Also, a shaft gear 160 may be coupled to one end of the drive shaft 130, and a sensor gear 170 may be meshed with the shaft gear 160 and coupled to one end of the rotation sensor 150. In this way, the rotation of the drive shaft 130 may be transferred easily and accurately via the shaft gear 160 and sensor gear 170 to the rotation sensor 150.

In cases where the automatic hinge module 100 according to this embodiment is employed in an apparatus for opening and closing a toilet bowl for opening or closing a cover or seat, for example, the rotational angle of the drive shaft 130 when the cover or seat is completely open or closed can be set beforehand. Then, during the operation of the motor 110, if the angle to which the drive shaft 130 has rotated corresponds to the preset angle, the rotation sensor 150 may generate a direction signal that causes the output shaft of the motor 110 to rotate in a forward or reverse direction and transfer the direction signal to the control unit (not shown).

Here, a state of being completely open or completely closed can refer to the cover being open to a degree that allows a user to use the toilet, or to the cover being closed to a degree that disallows the use of the toilet. This not only refers to the maximum value that can be provided by the equipment, but also encompasses the maximum value in terms of usage by the user. The same meaning will apply in the descriptions that follow.

When an open cover or seat is to be closed, there is a tendency for the cover or seat to bed closed by itself, due to the weight of the cover or seat, whereby it may not be necessary to operate the motor 110 until the cover or seat is completely closed. Therefore, in view of this tendency, the settings may include an angle at which to stop the motor 110 in advance, so that when the rotated angle corresponds to this preset angle, the rotation sensor 150 may generate a stop signal for stopping the motor 110 and transfer the stop signal to the control unit (not shown).

The rotation sensor 150 can be sealed from the exterior, and can be interposed between the housing 120 and the body of the motor 110. That is, a space for holding the rotation sensor 150 can be formed in the housing 120, and the rotation sensor 150 may be inserted into this space for coupling.

In this case, one end of the housing 120 may be coupled to the body of the motor 110 with a sealant 115 placed in-between, so that the rotation sensor 150 may be sealed without a separate component, making it possible to protect the rotation sensor 150 from outside moisture, etc., in a simpler manner.

Next, an apparatus for opening and closing a toilet bowl will be described, according to a second disclosed embodiment of the invention, which is equipped with an automatic hinge module based on the first disclosed embodiment.

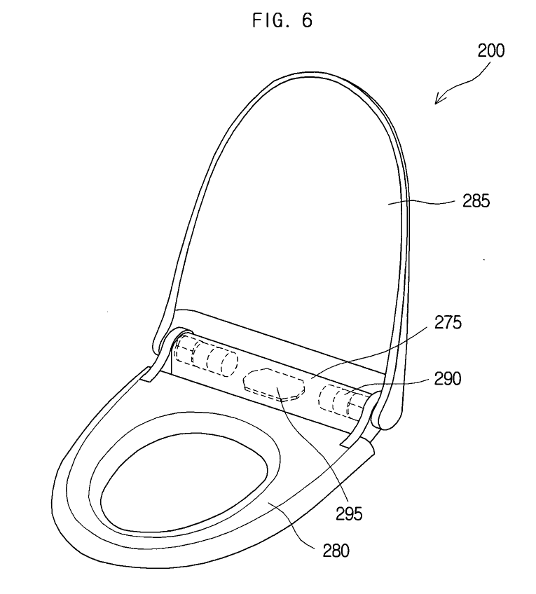

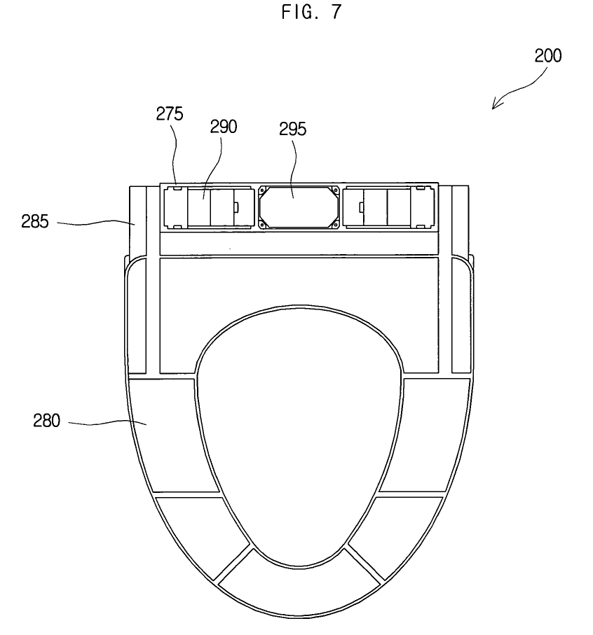

FIG. 6 is a perspective view of an apparatus for opening and closing a toilet bowl according to a second disclosed embodiment of the invention, and FIG. 7 is a bottom view of an apparatus for opening and closing a toilet bowl according to the second disclosed embodiment of the invention.

In FIG. 6 and FIG. 7, there are illustrated an apparatus 200 for opening and closing a toilet bowl, an automatic hinge module 290, a control unit 295, a base 275, a seat 280, and a cover 285.

In this embodiment, an apparatus 200 for opening and closing a toilet bowl is disclosed, in which two motors may be coupled to a base 275, and two drive shafts may be coupled to a cover 285 and a seat 280 respectively, to automatically open and close the cover 285 and seat 280. The output shaft of a motor may be connected to a drive shaft such that their centers of rotation coincide, and a spring that supplements the driving force of the motor may be coupled to the housing and the drive shaft, to provide a smaller size for the apparatus 200. A rotation sensor can be coupled to the housing to sense the amount of rotation of the motor's output shaft and generate a corresponding output signal.

In this embodiment, the compositions and coupling relationships of the automatic hinge module 290, control unit 295, motor, sealant, housing, first securing indentation, housing body, housing cover, drive shaft, second securing indentation, spring, rotation sensor, shaft gear, and sensor gear are substantially the same as, or are in corresponding relationships with, the components described with respect to the first disclosed embodiment. As such, these will not be described in further detail, and the following will focus on differences from the first disclosed embodiment, which include the compositions and coupling relationships of the base 275, seat 280, and cover 285.

A base 275 may be coupled to the toilet bowl, and a seat 280 and a cover 285 may be rotatably coupled to the base 275. Automatic hinge modules 290, each having a motor, housing, drive shaft, spring, and rotation sensor, can be installed within the base 275.

Accordingly, the apparatus 200 for opening and closing a toilet bowl can simply be coupled to an existing toilet bowl, without having to provide additional processing to the toilet bowl, to automatically open and close the cover 285 and seat 280 using the driving force of the motor.

The seat 280 may be coupled to the base such that the seat 280 is capable of rotating about an imaginary axis of rotation. As the seat 280 may rotate about an imaginary axis of rotation in relation to the base 275 coupled to the toilet bowl, one end of the seat 280 may be coupled to the other end of the drive shaft, which is connected to the output shaft of the motor, so that the seat 280 may be opened and closed by the driving force of the motor.

That is, there may be multiple motors, housings, drive shafts, and springs, where one of the drive shafts may have the other end coupled with the seat 280, to thus transfer the driving force to the seat 280 and open or close the seat 280.

Here, the imaginary axis of rotation can refer to a line assumed that is assumed to serve as a center of rotation for a rotating component. The same meaning will apply in the descriptions that follow.

The cover 285 may be coupled to seat 280 such that the cover 285 is capable of rotating about an imaginary axis of rotation. As the cover 285 may rotate about the same imaginary axis of rotation as the center of rotation of the seat 280 in relation to the base 275 coupled to the toilet bowl, one end of the cover 285 may be coupled to the other end of the drive shaft connected to the output shaft of the motor, so that the cover 285 may be opened and closed by the driving force of the motor.

That is, there may be multiple motors, housings, drive shafts, and springs, where one of the drive shafts other than the one coupled to the seat 280 may have the other end coupled with the cover 285, to thus transfer the driving force to the cover 285 and open or close the cover 285.

A drive shaft may have the other end coupled to at least one of the seat 280 and the cover 285. That is, a drive shaft may be coupled to either the seat 280 or the cover 285, or a drive shaft may be coupled to both the seat 280 and the cover 285 respectively, to transfer the driving force. Thus, it is to be appreciated that in addition to the case illustrated in this particular embodiment, where the drive shafts of multiple automatic hinge modules 290 are coupled to each of the seat 280 and the cover 285 to rotate the seat 280 and cover 285 respectively, the invention also encompasses those cases where the other end of a drive shaft is coupled to the seat 280 to only rotate the seat 280, and those cases where the other end of a drive shaft is coupled to the cover 285 to only rotate the cover 285.

With certain embodiments of the invention as set forth above, the cover and seat of a toilet bowl can be opened and closed automatically, an elastic force can be provided that supplements the driving force of the motor when the cover and/or seat is opened or closed, and a signal for stopping the operation of the motor can be generated by sensing the rotation of the cover and seat.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention. As such, many embodiments other than those set forth above can be found in the appended claims.

What is claimed is:

1. An automatic hinge module comprising:
a motor configured to generate a driving force;
a housing having one end thereof coupled to a body of the motor;
a drive shaft rotatably coupled to the housing and having one end thereof coupled to an output shaft of the motor such that a center of rotation of the drive shaft coincides with a center of rotation of the output shaft and such that the drive shaft is capable of transferring the driving force to the exterior; and
a spring having one end thereof coupled to the housing and having the other end thereof coupled to the drive shaft such that the spring provides an elastic force to the drive shaft in a direction of rotation of the drive shaft.

2. The automatic hinge module of claim 1, wherein a first securing indentation is formed inside the housing, a portion of the first securing indentation having a width smaller than or equal to a diameter of the one end of the spring,
and the one end of the spring is held in the first securing indentation in a manner of a press fit.

3. The automatic hinge module of claim 1, wherein a second securing indentation is formed in the drive shaft, the second securing indentation opening towards one end of the drive shaft,
and the other end of the spring is held in the second securing indentation.

4. The automatic hinge module of claim 1, wherein the spring is a coil spring wound around a perimeter of the drive shaft.

5. The automatic hinge module of claim 1, further comprising:
a rotation sensor coupled to the housing and configured to sense a rotation angle of the drive shaft, when the drive shaft is rotated, and generate an output signal corresponding to the rotation angle.

6. The automatic hinge module of claim 5, wherein the rotation sensor generates a direction signal as the output signal, the direction signal configured to determine an operating direction of the motor.

7. The automatic hinge module of claim 5, wherein the rotation sensor generates a stop signal as the output signal, the stop signal configured to stop an operation of the motor.

8. The automatic hinge module of claim 5, further comprising:
a shaft gear coupled to one end of the drive shaft; and
a sensor gear meshed with the shaft gear and coupled to one end of the rotation sensor.

9. The automatic hinge module of claim 5, wherein the rotation sensor is sealed from the exterior.

10. The automatic hinge module of claim 9, wherein the rotation sensor is interposed between the housing and the body of the motor,
and one end of the housing is coupled to the body of the motor with a sealant interposed in-between.

11. An apparatus for opening and closing a toilet bowl, the apparatus comprising:
a base coupled to the toilet bowl;
a seat rotatably coupled to the base about an imaginary axis of rotation;
a cover rotatably coupled to the seat about the imaginary axis of rotation;
a motor coupled to the base and configured to generate a driving force;
a housing having one end thereof coupled to a body of the motor;
a drive shaft rotatably coupled to the housing, the drive shaft having one end thereof coupled to an output shaft of the motor, such that a center of rotation of the drive shaft coincides with a center of rotation of the output shaft, and having the other end thereof coupled to at least one of the seat and the cover; and
a spring having one end thereof coupled to the housing and having the other end thereof coupled to the drive shaft such that the spring provides an elastic force to the drive shaft in a direction of rotation of the drive shaft.

12. The apparatus of claim 11, comprising a plurality of motors, a plurality of housings, a plurality of drive shafts, and a plurality of springs,
wherein one of the drive shafts has the other end thereof coupled to the seat to transfer the driving force to the seat,
and another of the drive shafts has the other end thereof coupled to the cover to transfer the driving force to the cover.

13. The apparatus of claim 11, wherein a first securing indentation is formed inside the housing, a portion of the first securing indentation having a width smaller than or equal to a diameter of the one end of the spring,
and the one end of the spring is held in the first securing indentation in a manner of a press fit.

14. The apparatus of claim 11, wherein a second securing indentation is formed in the drive shaft, the second securing indentation opening towards one end of the drive shaft,
and the other end of the spring is held in the second securing indentation.

15. The apparatus of claim 11, wherein the spring is a coil spring wound around a perimeter of the drive shaft.

16. The apparatus of claim 11, further comprising:
a rotation sensor coupled to the housing and configured to sense a rotation of the drive shaft, when the drive shaft is rotated, and generate an output signal corresponding to the rotation.

17. The apparatus of claim 16, wherein the rotation sensor generates a direction signal as the output signal, the direction signal configured to determine an operating direction of the motor.

18. The apparatus of claim 16, wherein the rotation sensor generates a stop signal as the output signal, the stop signal configured to stop an operation of the motor.

19. The apparatus of claim 16, further comprising:
a shaft gear coupled to one end of the drive shaft; and
a sensor gear meshed with the shaft gear and coupled to one end of the rotation sensor.

20. The apparatus of claim 16, wherein the rotation sensor is sealed from the exterior.

21. The apparatus of claim 20, wherein the rotation sensor is interposed between the housing and the body of the motor,
and one end of the housing is coupled to the body of the motor with a sealant interposed in-between.
